(19) United States
(12) Patent Application Publication
(10) Pub. No.: US 2025/0341688 A1
(43) Pub. Date: Nov. 6, 2025

(54) PLUGGABLE FIBER-TO-CHIP COUPLING FOR WAFER SCALE CO-PACKAGED OPTICS

(71) Applicant: Lightmatter, Inc., Boston, MA (US)

(72) Inventors: Shashank Gupta, Newton, MA (US); Srinivasan Ashwyn Srinivasan, Toronto (CA); Sandeep Sane, Chandler, AZ (US); Sufi Ahmed, Chandler, AZ (US); Kaushik Patel, San Jose, CA (US)

(73) Assignee: Lightmatter, Inc., Boston, MA (US)

(21) Appl. No.: 19/196,232

(22) Filed: May 1, 2025

Related U.S. Application Data
(60) Provisional application No. 63/641,914, filed on May 2, 2024.
(60) Provisional application No. 63/708,479, filed on Oct. 17, 2024.

(51) Int. Cl. G02B 6/42

(52) U.S. Cl. CPC G02B 6/4261; G02B 6/4231; G02B 6/4243

(57) ABSTRACT

Described herein are pluggable fiber-attach-first techniques and related manufacturing methods for assembling photonic chips according to the fiber-attach-first technique. The techniques may be used in several fields including, but not limited to, 2D, 2.5D, and 3D package architectures, wafer scale packaging technologies, and transceiver technologies. A photonic device comprises a photonic stack, a glass substrate and epoxy configured to hold the photonic stack and the glass substrate together. The photonic stack comprises one or more alignment features. The glass substrate comprises one or more alignment features, wherein each of the one or more alignment features of the glass substrate engage with a corresponding alignment feature of the photonic stack such that one or more waveguides of the photonic stack are optically coupled with one or more glass waveguides of the glass substrate.

### CROSS-REFERENCE TO RELATED APPLICATIONS

This application claims priority under 35 U.S.C. § 119 (e) to and is a non-provisional application of U.S. Patent Application Ser. No. 63/641,914, filed on May 2, 2024 entitled “PLUGGABLE FIBER-TO-CHIP COUPLING FOR WAFER SCALE CO-PACKAGED OPTICS,” and of U.S. Patent Application Ser. No. 63/708,479, filed on Oct. 17, 2024 entitled “PLUGGABLE FIBER-TO-CHIP COUPLING FOR WAFER SCALE CO-PACKAGED OPTICS,” the entire contents of which are hereby incorporated by reference in their entirety.

### BACKGROUND

Co-packaged optics are a differentiating technology that brings photonic integrated circuits (PICs) closer to electronic integrated circuits (EICs). Efficient coupling of light between an optical fiber and the PIC is desirable for such a system.

### SUMMARY OF THE DISCLOSURE

According to some aspects described herein, a method of manufacturing an optical device is provided. The method comprises: obtaining a photonic stack, the photonic stack having one or more exposed alignment features; and attaching a glass substrate to the photonic stack by aligning the one or more exposed alignment features of the photonic stack with one or more corresponding alignment features of the glass substrate such that one or more waveguides in the photonic stack are optically coupled with one or more glass waveguides in the glass substrate.

In some embodiments, the photonic stack comprises a substrate, a buried oxide (BOX) layer disposed on the substrate, a waveguide layer disposed on the BOX layer, and a back-end-of-line (BEOL) layer disposed on the waveguide layer, the one or more exposed alignment features are formed in the waveguide layer and at least a portion of the BOX layer, and the one or more waveguides in the photonic stack are formed in the waveguide layer.

In some embodiments, the one or more exposed alignment features are exposed from the photonic stack by a silicon-selective etch that does not etch silicon present in the waveguide layer.

In some embodiments, the photonic stack further comprises one or more cavities formed in a substrate; and attaching the glass substrate to the photonic stack comprises inserting one or more corresponding protrusions of the glass substrate into the one or more cavities of the photonic stack. In some embodiments, the one or more exposed alignment features are disposed in the one or more cavities of the photonic stack. In some embodiments, the one or more cavities have a width greater than a width of the one or more alignment features and a depth less than a height of the one or more alignment features. In some embodiments, the depth of the one or more cavities is between 10-20 μm. In some embodiments, the one or more cavities are located between at least a subset of the one or more alignment features.

In some embodiments, attaching the glass substrate to the photonic stack comprises applying mechanically strong epoxy between the glass substrate and the photonic stack to secure the glass substrate with the photonic stack. In some embodiments, applying the mechanically strong epoxy comprises applying the mechanically strong epoxy in the one or more cavities in the photonic stack.

In some embodiments, attaching the glass substrate to the photonic stack is performed without using v-grooves to couple the one or more waveguides in the photonic stack with one or more glass waveguides in the glass substrate.

In some embodiments, the one or more exposed alignment features of the photonic stack comprise alignment pillars and the corresponding alignment features of the glass substrate comprise grooves.

In some embodiments, the one or more waveguides in the photonic stack and the one or more glass waveguides of the glass substrate are optically coupled via edge coupling or evanescent coupling.

According to some aspects described herein, an optical device is provided. The optical device comprises: a photonic stack comprising one or more alignment features; a glass substrate comprising one or more alignment features, wherein each of the one or more alignment features of the glass substrate engage with a corresponding alignment feature of the photonic stack such that one or more waveguides of the photonic stack are optically coupled with one or more glass waveguides of the glass substrate; and epoxy disposed between the photonic stack and the glass substrate, the epoxy configured to hold the photonic stack and the glass substrate together.

In some embodiments, the one or more alignment features of the photonic stack are configured to passively align the glass substrate with the photonic stack without using v-grooves.

In some embodiments, the one or more alignment features are configured to passively align the glass substrate with the photonic stack with sub-half-micron precision.

In some embodiments, the one or more alignment features comprise alignment pillars and the corresponding alignment features of the glass substrate comprise grooves.

In some embodiments, the photonic stack comprises a substrate, a buried oxide (BOX) layer disposed on the substrate, a waveguide layer disposed on the BOX layer, and a back-end-of-line (BEOL) layer disposed on the waveguide layer, wherein the one or more alignment features is formed in the waveguide layer and at least a portion of the BOX layer.

In some embodiments, the one or more waveguides of the photonic stack and the one or more glass waveguides are optically coupled via edge coupling or evanescent coupling.

In some embodiments, the optical device further comprises a ferrule coupled with the glass substrate, the ferrule comprising one or more coupling features configured to provide removable coupling of the ferrule with the glass substrate wherein: the glass substrate further comprises one or more ferrule alignment features coupled with the one or more coupling features on the ferrule.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a flow chart depicting an example method of manufacturing a photonic integrated circuit (PIC) for use in a pluggable optoelectronic system, according to some embodiments;

FIG. 1B depicts an example photonic stack on which the method of FIG. 1A may be performed, according to some embodiments;

FIG. 2 depicts the photonic stack of FIG. 1B having been etched according to a first mask, according to some embodiments;

FIG. 3 depicts the photonic stack of FIG. 1B having been further etched according to a second mask, according to some embodiments;

FIG. 4 depicts the etched photonic stack of FIG. 3 having an example glass substrate comprising glass waveguides coupled therewith, according to some embodiments;

FIG. 5 depicts the etched photonic stack of FIG. 3 having another example glass substrate coupled therewith, the glass substrate having alignment marks, according to some embodiments;

FIG. 6 depicts the etched photonic stack of FIG. 3 having another example glass substrate coupled therewith, the glass substrate and photonic stack being configured for evanescent coupling, according to some embodiments;

FIG. 7 depicts the etched photonic stack of FIG. 3 having another example glass substrate coupled therewith, the glass substrate having ferrule alignment notches, according to some embodiments;

FIG. 8A depicts a top view of an example ferrule for coupling with a PIC as described herein, according to some embodiments;

FIG. 8B depicts a side view of the ferrule of FIG. 8A for coupling with a PIC as described herein, according to some embodiments;

FIG. 9 depicts a device having an etched photonic stack coupled with a glass substrate configured for evanescent coupling, according to some embodiments;

FIGS. 10A-10D depict top view schematics of an example method for manufacturing an optical device using the PICs described herein, according to some embodiments;

FIGS. 11A-11D depict side view schematics of the example method of FIGS. 10A-10D, according to some embodiments.

### DETAILED DESCRIPTION

The inventors have recognized and appreciated a number of problems with conventional techniques for coupling optical fibers with chips such as a photonic integrated circuit (PIC). Conventionally, coupling is achieved by gluing the fiber to the PIC after an active or passive alignment between the two. Since the gluing operation is permanent and irreversible, any failure in the attached fiber can inadvertently lead to failure in the PIC and the whole system that the PIC is a part of. Moreover, given the permanent nature of the fiber-attach, the attachment step can only be performed at the end of the package assembly. In fact, if the fibers were permanently attached earlier in the process, the fibers would be left dangling throughout the rest of the assembly operations. In addition, fiber-attach is a relatively low yield operation as compared to the rest of the assembly operations. Performing a low-yield operation at the end of packaging can have a detrimental impact on the overall yield of the complete package.

Conventional methods for addressing the aforementioned problems typically utilize a fiber-first, pluggable technique of attachment to the PIC, which includes manufacturing a glass piece that is conformal to the v-grooves and consequently, utilizes the same passive mechanism for alignment and coupling of light. On the fiber side, the glass piece has mechanisms that allow for the pluggability of the fiber.

The inventors have recognized several limitations with these techniques that arise from the use of v-grooves. First, the pitch between the couplers on the PIC is limited by the dimension of the v-grooves. Conventionally, this pitch is of the order of 127 μm.

Second, it is difficult to achieve sub half micron alignment accuracy between the fiber and the PIC through the use of v-grooves. This is largely because the processing of v-grooves is intensive and requires a combination of very well controlled dry and wet etches. Lack of tight dimensional tolerance, in turn, calls for the use of large mode-field-diameter (MFD) edge couplers on the PIC to reduce the insertion loss variability. Use of large MFD couplers, however, leads to additional problems: (1) large MFD couplers typically require removing the silicon substrate underneath the coupler to avoid light leakage, thereby requiring very long suspended couplers (e.g., weak millimeter long cantilevers), which have a high risk of breakage during the assembly; and (2) the suspended coupler is typically filled with an index-matched epoxy (IME) to lower the insertion loss. The refractive index of the IME at operation wavelength should be less than the effective index of coupler mode at the facet of the PIC. If this constraint is not satisfied, coupled light may leak into the epoxy causing a failure. Typically, the effective index of well-designed couplers at the facet of the PIC is ˜1.45 and finding BGA reflow compatible epoxies with index <1.45 in the O-band and the C-band is challenging. A few epoxies that are available tend to lack the mechanical strength an epoxy should provide to the glass piece. Thus, a two-epoxy solution is often employed, in which a mechanically strong epoxy is applied where the glass piece sits in the v-groove and an optical IME is used underneath the couplers. This not only complicates the fiber attachment process but significantly reduces the unit yield as well.

Third, v-grooves are deep topographic trenches in the silicon substrate and, as such, can interfere with other key components of modern-day silicon systems. One such component are through-silicon-vias (TSVs), which form a key unit step in semiconductor wafer fabrication. In order to reveal the TSVs for contact formation, back side grinding is typically performed, which thins the substrate thickness to less than 100 μm. If v-grooves are also present with the TSVs, they present an integration challenge and typically require TSVs that are deeper than the v-grooves themselves. In addition, v-groovers also present the risk of crack propagation through the v-groove corners during back-side grind.

Fourth, v-grooves and the associated large MFD couplers are long and consequently take away a large area of the silicon, which could otherwise be utilized for some other functions.

Lastly, grating coupler-based fiber-attach methods suffer from high insertion loss, low optical bandwidth, polarization diversity challenges and the need for optical alignment.

The inventors have recognized and appreciated the aforementioned limitations with conventional fiber-to-chip coupling techniques and have developed the coupling techniques described herein to address one or more of the aforementioned problems. The techniques described herein use a pluggable fiber-attach-first technique and manufacturing methods for assembling photonic chips according to the fiber-attach-first technique. The techniques may be used in several fields including, but not limited to 2D, 2.5D, and 3D package architectures, wafer scale packaging technologies, and transceiver technologies.

The techniques may provide passive waveguide alignment without the use of v-grooves, and may allow for on-chip coupler pitch scaling down to sub-50 μm. Passive alignment techniques described herein may additionally or alternatively allow for sub-half-micron placement accuracy, increasing efficacy of the coupling and enabling the use of small MFD couplers rather than the suspended couplers of conventional techniques.

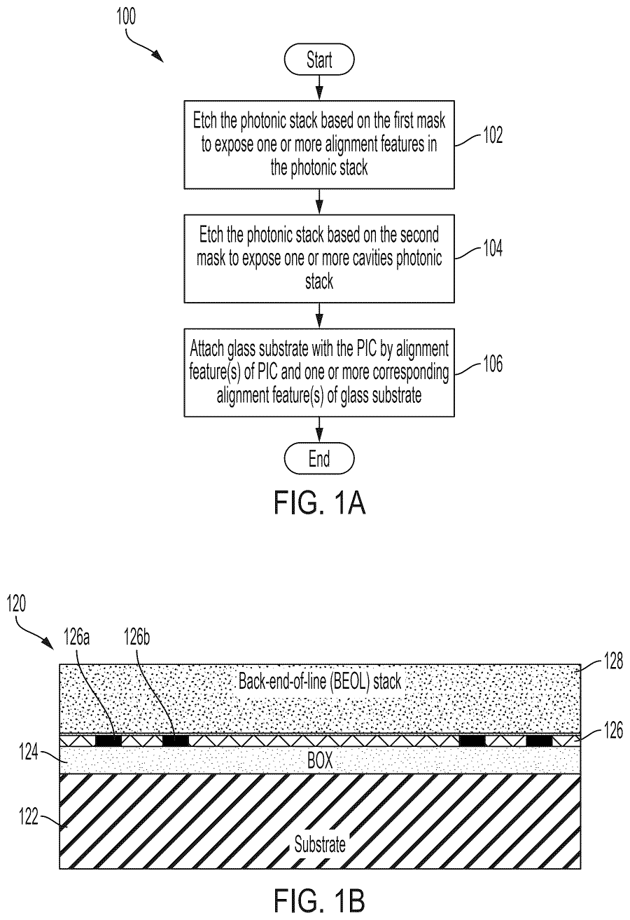

Some embodiments are directed to a method 100 of manufacturing a device (e.g., a PIC). FIG. 1A is a flowchart depicting an example method of manufacturing a PIC for use in a pluggable optoelectronic system, according to some embodiments. In some embodiments, the acts of method 100 may be performed during wafer-level processing and manufacturing to form a plurality of etched stacks efficiently.

Method 100 may begin at act 102, in which photonic stack 120 is etched based on the first mask to expose the one or more alignment features in the photonic stack. FIG. 1B depicts an example photonic stack 120 on which the method of FIG. 1A may be performed, according to some embodiments. In the illustrated embodiment, photonic stack 120 includes a substrate 122, buried oxide (BOX) layer 124, waveguide layer 126, and a back-end-of-line (BEOL) stack 128. The waveguide layer 126 may include a core material (e.g., silicon) and a lateral cladding material (e.g., oxide). Additionally, the waveguide layer 126 may be used to create alignment marks 126a and 126b. These alignment marks may be formed with very high precision because, for example, they are defined by lithography in a standard CMOS process and are located in the same plane (or very nearly the same plane) as the waveguides in which the light from a corresponding glass substrate (as described below) is eventually coupled to. However, FIG. 1B does not show these waveguides because they are outside the plane of the illustrated cross-section. In some embodiments, the wafer processing steps for the glass substrate occur after the back-of-end-line (BEOL) processes are complete on the PIC.

At act 102, a first mask may be applied to photonic stack 120. After the first mask is applied, photonic stack 120 is etched based on the first mask to expose the one or more alignment features in the photonic stack. FIG. 2 depicts the photonic stack of FIG. 1B having been etched according to a first mask, according to some embodiments. In the illustrated embodiment, photonic stack 120 is etched according to example first mask A.

In some embodiments, the exposed alignment features 132a and 132b may correspond to respective alignment features on the glass substrate so that the waveguides of the glass substrate may be aligned coupled with the waveguides in waveguide layer 126. The alignment features 132a and 132b may be defined according to and/or in relation to alignment marks 126a and 126b in the waveguide layer 126. Alignment marks 126a and 126b may be defined by a lithographic process to position the marks within the photonic stack with a precision of up to sub-half-micron accuracy. As such, when exposed during etching, alignment features 132a and 132b may be similarly precisely located up to sub-half-micron accuracy so as to ensure alignment of the waveguides in the photonic stack 120 with the glass waveguides in the glass substrate. In some embodiments, alignment features 132a and 132b may be in the form of alignment pillars as depicted in FIG. 2. However, this is for example purposes only and any suitable form of alignment features may be used, including, but not limited to, divots, cavities, grooves, protrusions, markings, or any other suitable features or combination thereof.

Further, in the illustrated embodiment, the subsequent etch process may remove the whole BEOL stack 128 from the starting stack. In some embodiments, the etch process may be a silicon-selective etch. For example, the etch process may also etch through the cladding oxide of the waveguide layer while being selective to silicon such that the silicon core material is not etched. In some embodiments, the etch can be stopped in the middle of the BOX layer. Etching photonic stack 120 in this manner may expose one or more high-precision alignment features 132a and 132b (e.g., alignment pillars) on the PIC, resulting in an etched stack.

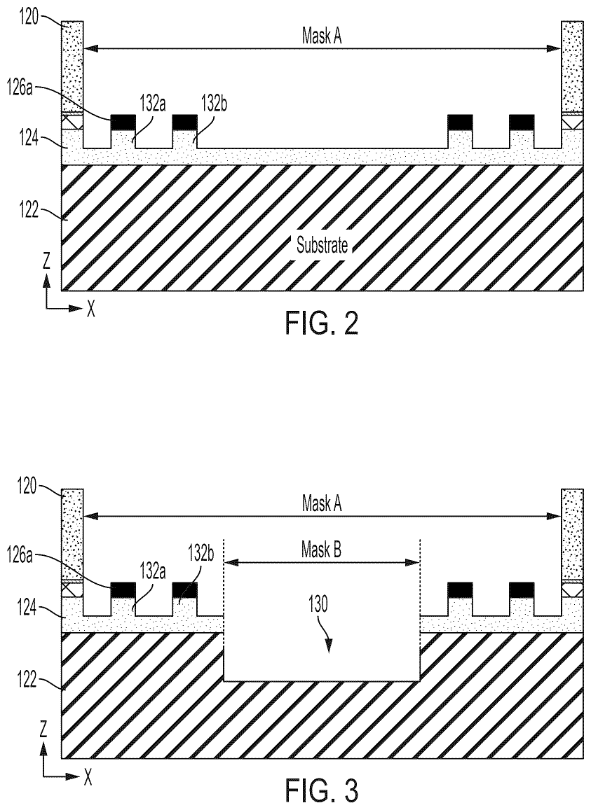

In some embodiments, method 100 may include, at act 104, further etching the photonic stack to form one or more cavities. For example, FIG. 3 depicts the photonic stack of FIG. 1B having been further etched according to an example second mask, according to some embodiments. The example second mask B may define an area in which the one or more cavities may be formed. In some embodiments, the glass substrate may sit within the one or more cavities which may correspond to the region where the waveguides in the glass substrate are located. Applying second mask B may include using lithography.

Having applied the second mask, the photonic stack may be further etched based on the second mask to form one or more cavities in the photonic stack. For example, the etching process may etch the remaining portion of the waveguide cladding material and a portion of the substrate. Thus, in some embodiments, at the end of the second masking process, the cavity 130 is formed in the silicon substrate, as shown in FIG. 3, resulting in a second-etched stack. The cavity formed by the second etch may have a width wider than the alignment features 132a and 132b and a depth less than the height of the alignment features 132a and 132b. In some embodiments, cavity 130 may be, for example, approximately 10-20 μm deep in the substrate, although the technology is not limited in this respect and any suitable portion of the substrate may be etched. Such a depth may be noticeably shallower than the v-grooves depth and may increase compatibility with TSVs over conventional v-groove based techniques. In some embodiments, the second mask may define more than one cavity to be etched.

The second-etched stack may provide cavity 130 which provides mechanical stability and coarse alignment of the glass substrates in the x-direction (depicted as the horizontal axis in FIG. 3) when the glass substrate is coupled with the second-etched stack. In some embodiments, a mechanically strong epoxy can be dispensed in this cavity without any interference to the optical performance. In some embodiments, the mechanically strong epoxy may have a tensile strength of over 50 MPa.

Additionally or alternatively, cavity 130 may enable large optical modes in the glass piece. Therefore, cavity 130 amortizes the space required for mechanical stability with any mode conversion necessary between the ˜9 μm fiber mode on one end of the glass piece to smaller (˜5 μm) mode on the PIC side. This can optionally be utilized to route the glass waveguides in the depth (z) dimension (depicted as the vertical axis in FIG. 3) reducing the insertion loss caused by light leaking into the PIC substrate when the cavity is not etched into the substrate.

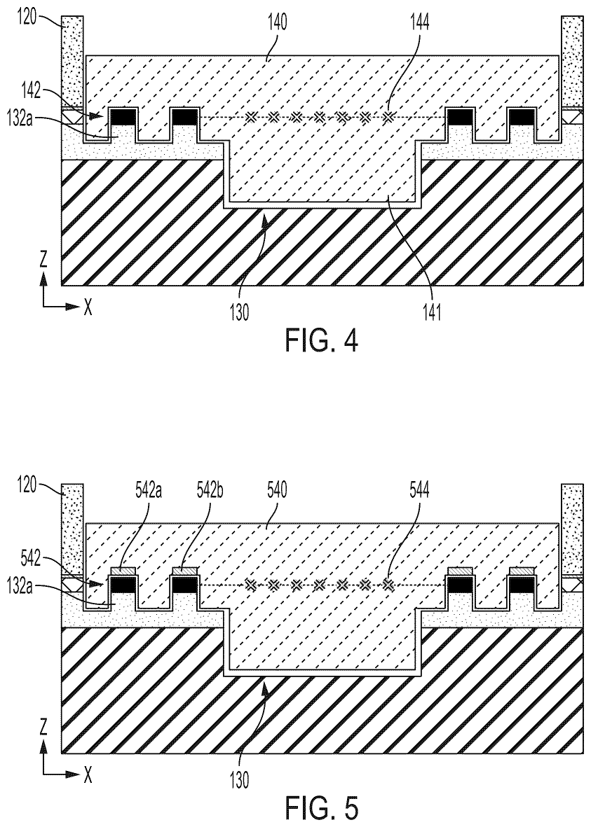

Having etched photonic stack 120 accordingly, at act 106, the glass substrate may be attached to the PIC using the alignment feature(s) of the PIC and the one or more corresponding alignment features of the glass substrate. FIG. 4 depicts the etched photonic stack 120 of FIG. 3 having an example glass substrate 140 attached to it, according to some embodiments. The figure illustrates the geometrical features and glass waveguides 144 of the glass substrate 140 according to some embodiments.

In the illustrated embodiment, the glass substrate 140 includes complementary alignment features to the alignment features of the PIC. For example, glass substrate 140 includes a plurality of alignment grooves 142 complementary to the alignment pillars (e.g., alignment feature 132a) of the PIC. That way, when glass substrate 140 is attached to photonic stack 120, alignment grooves 142 may engage with the alignment features 132a and 132b of photonic stack 120. Forming the plurality of alignment grooves 142 may be achieved, for example, using high-precision lithography and etching of the glass substrate. The depth of the alignment pillars may be, for example, of the order of 1.5-2 μm. In some embodiments, the alignment features on the glass are etched while maintaining tight alignment tolerance (e.g., sub-half-micron precision). Although glass substrate 140 is depicted as having alignment grooves 142, it can be appreciated that any corresponding alignment features may be suitable. The alignment features may be grooves, divots, marks, protrusions, pillars, studs, or any other suitable alignment features corresponding to the alignment features of the photonic stack. For example, rather than photonic stack 120 having alignment pillars, alignment features of glass substrate 140 may be alignment pillars, whereas the alignment features 132a and 132b of photonic stack 120 may be alignment grooves so as to engage with alignment pillars on the glass substrate.

Glass substrate 140 includes glass waveguides 144 precisely placed with respect to the alignment marks (e.g., alignment marks 126a and 126b of FIG. 1B). This may be achieved using, for example, methods such as laser writing. The glass waveguides 144 are aligned with the couplers on the PIC with high precision (e.g., at least better than half a micron) since the MFD of the couplers is of the order of 5 μm for suspension-less operation and low loss. As discussed above, suspension-less operation enables this coupling technique without the use of IME and results in a simpler process (although IME may be used in some embodiments). Rather, as noted above, glass substrate 140 may be coupled to etched photonic stack 120 by applying mechanically strong epoxy to cavity 130. In embodiments having cavity 130, the mechanically strong epoxy may be disposed in cavity 130 and corresponding protrusion 141 of glass substrate 140 may be inserted into cavity 130 to be held in place by the mechanically strong epoxy.

In some embodiments, higher precision alignment of glass substrate 140 may be achieved using extra alignment marks on glass substrate 140. This can be accomplished by having marks in the glass that can be mated to the alignment features in the PIC through visual techniques. FIG. 5 depicts the etched photonic stack 120 of FIG. 3 having another example glass substrate 540 coupled therewith, the glass substrate 540 having alignment marks, according to some embodiments. In the illustrated embodiment, glass substrate 540 includes alignment marks (e.g., 542a and 542b) marked within the alignment features 542 (e.g., alignment grooves). In some embodiments, the two optical mating features on the PIC (e.g., alignment marks 126a and 126b) and the glass (e.g., alignment marks 542a and 542b) are in close proximity so that they can be resolved with a narrow depth of field on an imaging device. In cases where the fine mating features are not included on the glass, these optical alignment marks may be used for high precision alignment by themselves.

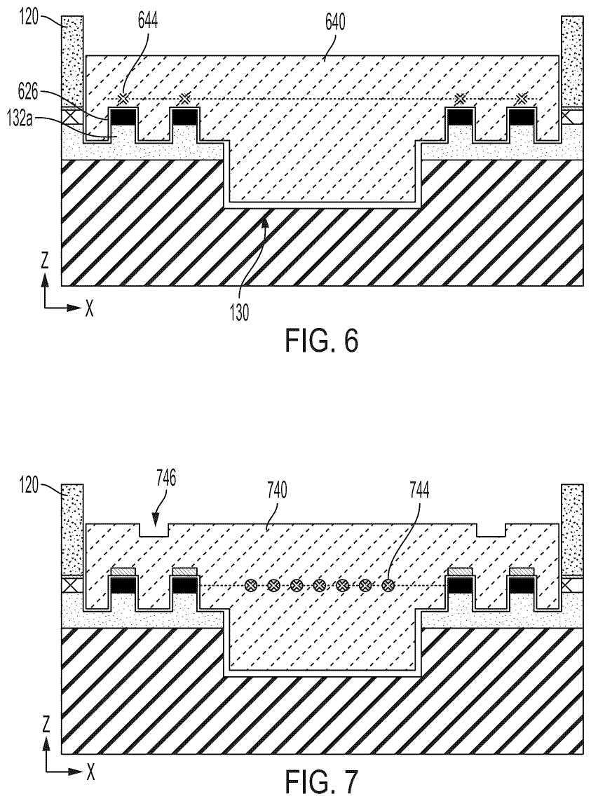

In some embodiments, the photonic stack and the glass substrate may be configured for evanescent coupling, rather than edge coupling as depicted in the example embodiments of FIGS. 4 and 5. Evanescent coupling may provide robust tolerance to misalignments as compared to edge coupling. FIG. 6 depicts the etched photonic stack 120 of FIG. 3 having another example glass substrate 640 coupled therewith, the glass substrate 640 and the photonic stack 120 being configured for evanescent coupling, according to some embodiments. In the illustrated embodiment, the alignment features (e.g., alignment feature 132a) on photonic stack 120 may also form the waveguides 626 of the PIC. As such, waveguides 626 may be evanescently coupled with glass waveguides 644 of glass substrate 640. While evanescent coupling may provide robustness to misalignments, the physical gap between the glass waveguides and the PIC waveguides may be reduced to reduce leakage into the substrate. As such, in the illustrated embodiment, glass waveguides 644 are disposed adjacent to PIC waveguides 626 to reduce leakage of light to the substrate. Other features described above with respect to FIGS. 4 and 5 may additionally be included such as the cavity 130, which may be used for mechanical strength, coarse alignment, and waveguide routing in the glass, and the optical alignment marks (e.g., alignment marks 542a and 542b).

The methods and steps described above are examples of a technique that the inventors recognized can be modified based on the process available at any particular foundry. The techniques described herein represent a process that may be used to attach a glass piece with high precision to a PIC while eliminating the need for costly active alignment to achieve acceptable insertion loss.

As noted above, the inventors have recognized and appreciated that conventional fiber-chip coupling techniques rely on permanent couplings. As such, in some embodiments, the glass substrate may provide mechanisms to have pluggable fibers on one end. FIG. 7 depicts the etched photonic stack 120 of FIG. 3 having another example glass substrate 740 coupled therewith, the glass substrate 740 having alignment notches, according to some embodiments. In some embodiments, the PIC (or other optical device) may be made pluggable by attaching a glass ferrule to the glass substrate 740. As such, in the illustrated embodiment, glass substrate 740 includes alignment notches 746 for aligning and attaching a ferrule to glass substrate 740. This may be achieved by etching the alignment notches 746 on a top surface of the glass substrate 740, so that the ferrule can be attached with passive alignment.

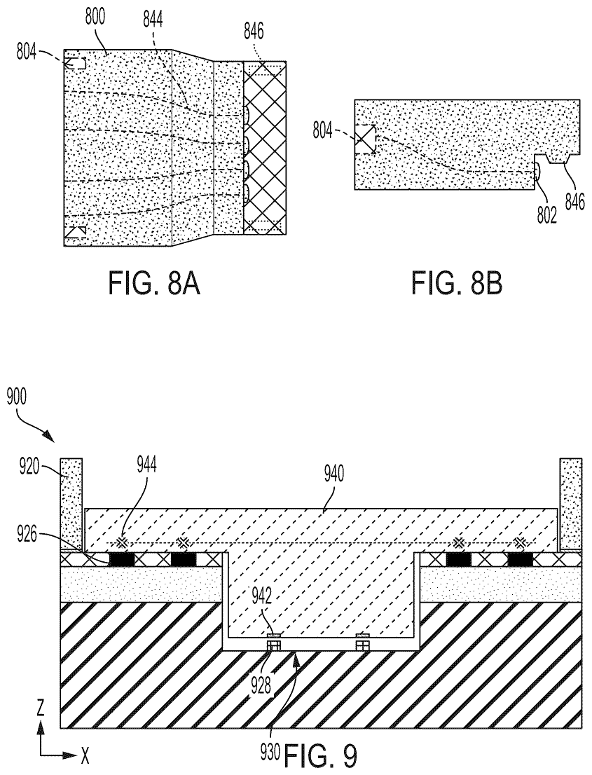

FIG. 8A depicts a top view of an example ferrule 800 for coupling with a PIC as described herein, according to some embodiments. FIG. 8B depicts a side views of the ferrule 800 of FIG. 8A for coupling with a PIC as described herein, according to some embodiments. In the illustrated embodiment, ferrule 800 includes one or more alignment studs 846, one or more waveguides 844, one or more lenses 802, and one or more connector alignment features 804. Alignment studs 846 may be configured to be coupled with the alignment notches 746 of glass substrate 740. In that way, ferrule 800 may be passively aligned with glass substrate 740. When ferrule 800 is coupled with the glass substrate 740, waveguides 844 may be placed in alignment with the waveguides on the glass substrate (e.g., glass waveguides 744). In some embodiments, ferrule 800 may include one or more lenses 802 disposed on a side of the ferrule facing the glass substrate (e.g., glass substrate 740). Lenses 802 may improve the efficiency of coupling ferrule 800 with the glass substrate by providing mode expansion and/or for increasing tolerance to misalignment.

Ferrule 800 may additionally include one or more attachment features 804 configured to support pluggable and removable attachment of optical fibers to ferrule 800. In that way, ferrule 800 may enable and facilitate pluggable coupling of the optical fibers to the PIC. In some embodiments, attachment features 804 may be configured to receive corresponding attachment portions of an optical fiber connector to connect one or more optical fibers with the PIC. For example, in some embodiments, attachment features 804 may be configured to receive a multi-fiber push on (MPO) connector for connecting a plurality of optical fibers with the PIC. In that way, the ferrule may provide pluggable (e.g., removable) attachment of the optical device with the one or more optical fibers.

In some embodiments, it may be beneficial to provide a simpler integration method between the glass substrate and the PIC. FIG. 9 depicts a device 900 having an etched photonic stack 920 coupled with a glass substrate 940 configured for evanescent coupling, according to some embodiments. As described above, both photonic stack 920 and the glass substrate 940 may each have corresponding alignment marks 928 and 942 respectively. However, alignment marks 928 of the stack and alignment marks 942 of the glass may be disposed in the etched cavity 930, and as such, can be used to align glass substrate 940 with photonic stack 920 without the alignment features of the previously described embodiments, (e.g., alignment features 132a and 132b).

Further, in some embodiments, epoxy used to bond the glass substrate 940 and photonic stack 920 may only be disposed within cavity 930 while leaving waveguides 926 of the stack and glass waveguides 944 of the glass bare. In that way, the bond line between the glass waveguides 944 and stack waveguides 926 may be reduced, leading to higher coupling efficiency and shorter couplers. As such, the stack waveguides 926 may be exposed through a standard back-end etch process. In some embodiments, a thin back-end oxide film can be left on top of stack waveguides 926.

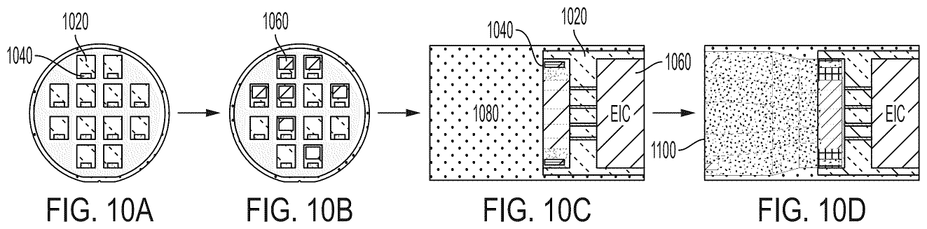

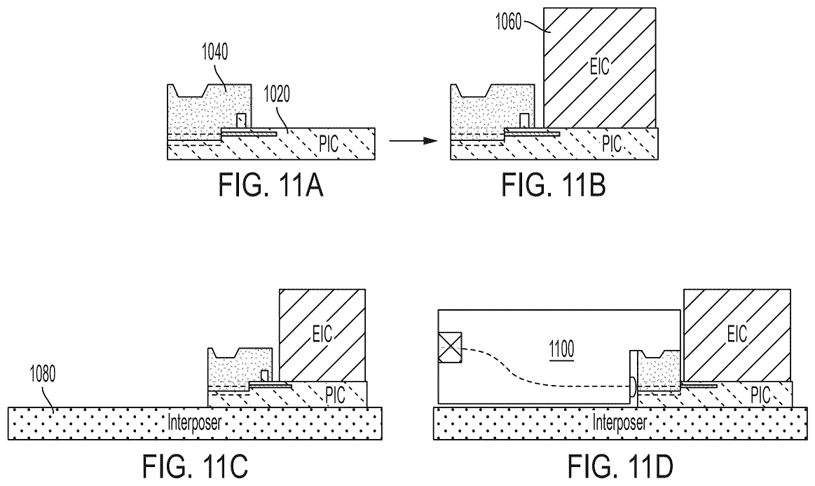

FIGS. 10A-10D depict a top view schematic of an example method for manufacturing an optical device using the PICs described herein, according to some embodiments. FIGS. 11A-11D depict side view schematics of the example method of FIGS. 10A-10D, according to some embodiments. In the illustrated embodiments, steps 1 and 2 (FIGS. 10A/11A and 10B/11B respectively) may be performed at the wafer level having formed a plurality of photonic stacks on a semiconductor wafer, whereas steps 3 and 4 (FIGS. 10C/11C and 10D/11D respectively) may be performed on an individual stack-by-stack basis.

At step 1, as depicted in FIGS. 10A and 11A, glass substrates 1040 may be respectively coupled with each of the plurality of photonic stacks 1020 in a wafer. Step 1 may be performed, for example as described above with respect to FIGS. 1-9. After attachment of the glass substrate 1040, one or more optical tests may be conducted to ensure alignment of the pieces and functionality of the PIC with respect to propagating optical signals.

Once tested, at step 2, as depicted in FIGS. 10B and 11B, an electronic integrated circuit (EIC) 1060 may be attached to the PIC. In some embodiments, EIC 1060 may be attached on a side of photonic stack 1020 opposite that of the glass substrate 1040. EIC 1060 may be any suitable component, for example, an application specific integrated circuit (ASIC), a processor, a controller, a graphic processing unit, a switch chips, etc. Once attached, each of the resulting PICs may be debonded from the wafer.

At step 3, as depicted in FIGS. 10C and 11C, a debonded PIC may be attached using any suitable method to an interposer 1080. The interposer 1080 may support a ferrule coupled with the PIC as described herein.

At step 4, as depicted in FIGS. 10D and 11D, a ferrule 1100 may be attached to the PIC by coupling the ferrule 1100 to the glass substrate 1040 as described herein, for example, with respect to FIGS. 8-9.

Both steps 3 and 4 may be performed via any suitable method known in the art for attaching the various components to semiconductor chips.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the technology described herein may be used alone, in combination, or in a variety of arrangements not specifically described in the embodiments described in the foregoing and is therefore not limited in its application to the details and arrangement of modules set forth in the foregoing description or illustrated in the drawings. For example, aspects described in one embodiment may be combined in any manner with aspects described in other embodiments.

Also, the technology described herein may be embodied as a method, of which examples are provided herein. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of manufacturing an optical device, the method comprising:
obtaining a photonic stack, the photonic stack having one or more exposed alignment features; and
attaching a glass substrate to the photonic stack by aligning the one or more exposed alignment features of the photonic stack with one or more corresponding alignment features of the glass substrate such that one or more waveguides in the photonic stack are optically coupled with one or more glass waveguides in the glass substrate.

2. The method of claim 1, wherein:
the photonic stack comprises a substrate, a buried oxide (BOX) layer disposed on the substrate, a waveguide layer disposed on the BOX layer, and a back-end-of-line (BEOL) layer disposed on the waveguide layer,
the one or more exposed alignment features are formed in the waveguide layer and at least a portion of the BOX layer, and
the one or more waveguides in the photonic stack are formed in the waveguide layer.

3. The method of claim 2, wherein the one or more exposed alignment features are exposed from the photonic stack by a silicon-selective etch that does not etch silicon present in the waveguide layer.

4. The method of claim 1, wherein:
the photonic stack further comprises one or more cavities formed in a substrate; and
attaching the glass substrate to the photonic stack comprises inserting one or more corresponding protrusions of the glass substrate into the one or more cavities of the photonic stack.

5. The method of claim 4, wherein the one or more exposed alignment features are disposed in the one or more cavities of the photonic stack.

6. The method of claim 4, wherein the one or more cavities have a width greater than a width of the one or more alignment features and a depth less than a height of the one or more alignment features.

7. The method of claim 6, wherein the depth of the one or more cavities is between 10-20 μm.

8. The method of claim 4, wherein the one or more cavities are located between at least a subset of the one or more alignment features.

9. The method of claim 4, wherein attaching the glass substrate to the photonic stack comprises applying mechanically strong epoxy between the glass substrate and the photonic stack to secure the glass substrate with the photonic stack.

10. The method of claim 9, wherein applying the mechanically strong epoxy comprises applying the mechanically strong epoxy in the one or more cavities in the photonic stack.

11. The method of claim 1, wherein attaching the glass substrate to the photonic stack is performed without using v-grooves to couple the one or more waveguides in the photonic stack with one or more glass waveguides in the glass substrate.

12. The method of claim 1, wherein the one or more exposed alignment features of the photonic stack comprise alignment pillars and the corresponding alignment features of the glass substrate comprise grooves.

13. The method of claim 12, wherein the one or more waveguides in the photonic stack and the one or more glass waveguides of the glass substrate are optically coupled via edge coupling or evanescent coupling.

14. An optical device comprising:
a photonic stack comprising one or more alignment features;
a glass substrate comprising one or more alignment features, wherein each of the one or more alignment features of the glass substrate engage with a corresponding alignment feature of the photonic stack such that one or more waveguides of the photonic stack are optically coupled with one or more glass waveguides of the glass substrate; and
epoxy disposed between the photonic stack and the glass substrate, the epoxy configured to hold the photonic stack and the glass substrate together.

15. The optical device of claim 14, wherein the one or more alignment features of the photonic stack are configured to passively align the glass substrate with the photonic stack without using v-grooves.

16. The optical device of claim 15, wherein the one or more alignment features are configured to passively align the glass substrate with the photonic stack with sub-half-micron precision.

17. The optical device of claim 14, wherein the one or more alignment features comprise alignment pillars and the corresponding alignment features of the glass substrate comprise grooves.

18. The optical device of claim 14, wherein:
the photonic stack comprises a substrate, a buried oxide (BOX) layer disposed on the substrate, a waveguide layer disposed on the BOX layer, and a back-end-of-line (BEOL) layer disposed on the waveguide layer,
wherein the one or more alignment features is formed in the waveguide layer and at least a portion of the BOX layer.

19. The optical device of claim 14, wherein the one or more waveguides of the photonic stack and the one or more glass waveguides are optically coupled via edge coupling or evanescent coupling.

20. The optical device of claim 14, further comprising:
a ferrule coupled with the glass substrate, the ferrule comprising one or more coupling features configured to provide removable coupling of the ferrule with the glass substrate wherein:
the glass substrate further comprises one or more ferrule alignment features coupled with the one or more coupling features on the ferrule.
